(19) United States
(12) Patent Application Publication
(10) Pub. No.: US 2011/0035246 A1
(43) Pub. Date: Feb. 10, 2011

(54) DEVICES, SYSTEMS, AND METHODS FOR AIDING IN PEST MANAGEMENT DECISIONS

(75) Inventors: Wayne Alan Fithian, Elkhorn, NE (US); Larry Von Kaster, JR., Ames, IA (US); Horacio R. Buscaglia, Greenwood, MN (US); Bruce A. Battles, Ames, IA (US); Tracy L. Mader, Maple Grove, MN (US)

Correspondence Address: Womble Carlyle Sandridge & Rice PLLC, Attention: IP Docketing, P.O. Box 7037, Atlanta, GA, 30357-0037, US

(73) Assignee: SYNGENTA PARTICIPATIONS AG

(21) Appl. No.: 12/839,899

(22) Filed: Jul. 20, 2010

Related U.S. Application Data
(60) Provisional application No. 61/232,566, filed on Aug. 10, 2009.

(51) Int. Cl. G06Q 10/00

(52) U.S. Cl. 705/7

(57) ABSTRACT

A computer device is provided for implementing a system configured to provide pest management information used in pest management decision-making related to a site-specific crop of interest. The computer device receives a pest input value for each of a plurality of pest populations. The pest input values correspond to pest sampling data associated with the pest populations for the site-specific crop. The computer device further determines a multiple-pest economic threshold value associated with the site-specific crop from the pest input values. The computer device further determines a predicted investment cost value from the multiple-pest economic threshold value, wherein the predicted investment cost is indicative of the return on investment associated with use of a pest control strategy for the site-specific crop. The computer device further provides an indicia of the predicted investment cost value according to the pest input values. Associated systems and methods are also provided.

### CROSS-REFERENCE TO RELATED APPLICATION

This application claims the benefit of U.S. Provisional Application No. 61/232,566, filed Aug. 10, 2009, which is hereby incorporated herein in its entirety.

### BACKGROUND

1. Field of the Disclosure

The present disclosure relates to the field of pest management and, more specifically, to systems, devices, and methods for providing return on investment information to a crop grower as determined by multiple-pest economic threshold values such that more informed pest management decisions can be made with respect to a site-specific crop of interest.

2. Description of Related Art

Pest management is an economic endeavor and, as such, it is part of the cost of producing an agricultural commodity. Pest assessment seeks to reduce pest management costs by reducing the uncertainty about whether or not a pest is sufficiently dense to cause economic damage to the crop. Equally important, such assessments also seek to minimize the unnecessary use of a control measure (e.g., chemical pesticides) when pest densities are below a critical density because they increase production costs. Unnecessary treatments can be largely eliminated with an appropriate pest assessment protocol. Such pest assessment protocols must be cost effective (i.e., the protocols must cost less to acquire the information needed for a prudent decision than it costs to routinely treat a pest or to endure the economic loss by always ignoring the pest).

Previously, pest management assessments have included the use of economic thresholds. In general, economic threshold is defined as the pest population that produces incremental damage equal to the cost of controlling or preventing that damage. It is the level of pest population where the benefit of pest control is equal to its cost. In this regard, economic threshold may be defined as the pest damage level where the value of incremental reduction in crop yield is equal to the cost of preventing its occurrence. In other words, economic threshold attempts to determine the point at which it becomes economically feasible to control a pest population. In this regard, economic thresholds are used to enable strategic implementation of a pest control action, such as chemical control measures (i.e., using pesticides). The economic threshold concept is based on the assumption that farmers are profit maximizers that will make pest management decisions on the basis of the profit to be derived from a particular pest control activity. A profit-maximizing farmer would likely make pest management decisions on the basis of threshold values.

However, economic thresholds typically assume only one pest (i.e., single pest economic thresholds), when in fact multiple pest species are sometimes present in a field at the same or different times. In some instances, cumulative damage caused by a combination of pests may be above an economic level, even though each pest is below its individual economic threshold. Furthermore, the presence of one pest may cause the damage inflicted by another pest to become enhanced. Previous attempts to account for the cumulative damage of multiple pests have only included examining pest populations that are simultaneously active on a crop (i.e., more than one pest population present at the same time). Such limitations were necessary due to the use of thresholds to determine the economics of a single insecticide application aimed at controlling more than one pest at the same time. However, pests are typically active at either the same or different times.

Therefore, it would be advantageous to provide methods and computer program products capable of determining multiple-pest thresholds for a crop of interest at a site-specific area, as particularly determined from user inputs, such as, for example, crop market price, transgenic seed price, planting rate, target yield, and specific pest-related data, so as to provide a user with pest management information based on multiple pest occurrences and the cumulative effects thereof as applied to pest populations active at differing times.

### BRIEF SUMMARY OF THE DISCLOSURE

The needs outlined above are met by the present disclosure which, in various aspects, provides a pest management method, system, and/or device that overcomes many of the technical problems discussed above, as well other technical problems, with regard to the providing of multiple-pest information used to make pest management assessments and/or decisions for a site-specific crop.

The above and other needs are met by the present disclosure which, in one aspect, provides a method for providing pest management information used in pest management decision-making for a site-specific crop of interest. Such a method comprises receiving from a user a plurality of pest input values associated with a respective plurality of pest populations. The input values correspond to pest sampling data associated with the respective pest populations for a site-specific crop of interest. The method further comprises determining a multiple-pest economic threshold value associated with the site-specific crop of interest from the pest input values. Further, the method comprises determining a predicted return on investment value from the multiple-pest economic threshold value, wherein the return on investment value is indicative of the return on investment associated with use of a pest control strategy for the site-specific crop of interest. In addition, the method comprises providing an indicia of the predicted return on investment value, so as to provide pest management information to the user for aiding in pest management decisions. In some aspects, the method may further comprise receiving a crop market price input associated with a market price of the site-specific crop of interest, and a transgenic seed price input associated with a market price of a transgenic seed used to control the pest populations with respect to the site-specific crop of interest. The crop market price input and the transgenic seed price input are used to determine the predicted return on investment value, and such investment value can then be compared to the investment value of using a chemical control method or otherwise compared to taking no pest control action.

Another advantageous aspect of the present disclosure comprises a system for implementing the associated method for providing pest management information used in pest management decision-making, as described herein. Such a system may be implemented in computer hardware, software, or a combination of computer software and hardware, having one or more executable and/or processing portions for accomplishing an associated method according to other aspects of the present disclosure. In a representative aspect, a pest management system is at least partially initiated and established on an intermediary computer or computer device, capable of implementing the described associated method, that is part of a larger computer network such as, for example, the Internet. Such an intermediary computer or computer device may comprise, for example, a desktop personal computer, a laptop personal computer, a server, a router, a mainframe computer or like devices or combinations thereof capable of implementing the described functions as known to one skilled in the art. Once established on the intermediary computer or computer device, the pest management system is accessible to a customer (also referred to herein as “user” or “consumer”) via a user's computer device (which also may comprise a part of the pest management system) that is discrete with respect to the intermediary computer or computer device, but capable of communicating with the computer network and, as a result, with the intermediary computer or computer device through, for example, network communication lines. According to other aspects, the computer device may be capable of implementing the associated method in a stand alone manner and not forming part of a larger network, in which the one or more executable and/or processing portions are capable of execution/processing on the computer device without the aid of a larger network.

Thus the methods, systems, and devices for providing pest management-related information used in pest management decision-making, as described in the aspects of the present disclosure, provide many advantages that may include, but are not limited to: providing a pest management system that provides a user with return on investment information for a particular pest control strategy, and providing a comparison of return on investment for various pest control strategies.

These advantages and others that will be evident to those skilled in the art are provided in the methods, systems, and devices of the present disclosure. Importantly, all of these advantages allow a user to more effectively and efficiently make pest management assessments.

### BRIEF DESCRIPTION OF THE SEVERAL VIEWS OF THE DRAWINGS

Having thus described the disclosure in general terms, reference will now be made to the accompanying drawings, which are not necessarily drawn to scale, and wherein:

FIG. 1 is a schematic representation of a system for providing a user with pest management information based on multiple pest data provided by the user, according to one aspect of the present disclosure;

FIG. 2 is a schematic representation of a computer device for providing a user with pest management information based on multiple pest data provided by the user, according to one aspect of the present disclosure;

FIG. 3 illustrates a display according to one aspect of the present disclosure wherein a user may view indicia of return on investment information according to various pest control strategies for managing multiple pest populations;

FIG. 4 is a flow chart of a method according to one aspect of the present disclosure including the steps of receiving a first and second pest input value associated with a respective first and second pest population, determining a multiple-pest economic threshold value associated with the site-specific crop of interest from the first and second pest input values, determining a predicted return on investment value from the multiple-pest economic threshold value, and providing an indicia of the predicted return on investment value;

FIG. 5 illustrates a display according to another aspect of the present disclosure wherein a user may view indicia of return on investment information according to various pest control strategies for managing multiple pest populations; and

FIG. 6 illustrates a display incorporating a graphical representation comparing various methods of pest control strategies, according to one aspect of the present disclosure.

### DETAILED DESCRIPTION OF THE DISCLOSURE

The present disclosure now will be described more fully hereinafter with reference to the accompanying drawings, in which some, but not all aspects of the disclosure are shown. Indeed, this disclosure may be embodied in many different forms and should not be construed as limited to the aspects set forth herein; rather, these aspects are provided so that this disclosure will satisfy applicable legal requirements. Like numbers refer to like elements throughout.

The various aspects of the present disclosure mentioned above, as well as many other aspects of the disclosure are described in greater detail below. The methods, systems, and devices of the present disclosure are described in a pest management decision-making environment, wherein the users provide information related to the multiple pests with respect to a site-specific crop of interest, such that the benefits of the methods, systems, and devices may extend to increased commodity production. In general, a user collects current or recalls historical sampling data related to a plurality of pest populations, wherein the sampling data is used to develop an economic threshold specific to the particular pest populations at a particular site of interest and for a particular crop of interest. In addition, the user may receive, in response to inputting the pest sampling data, information related to the return on investment for employing a pest control strategy, such as a chemical pesticide or a transgenic seed product which is insect resistant. For example, the transgenic seed product may be an AGRISURE® maize product sold under the trademark VIPTERA™, available through Syngenta Seeds, Incorporated, which may be used to control a broad spectrum of lepidopteran and coleopteran insect pests. As such, the user benefits by increasing the available information for making assessments of using a particular pest control strategy in favor of another, or none at all, as well as improving the return on investment information as it includes cumulative effects of the multiple pest populations as determined by the multiple-pest economic threshold. The methods, systems, and devices of the present disclosure can be used by any number of interested parties. For example, the present disclosure may be used by crop growers, sellers of pest control measures (i.e., sellers of chemical pesticides, seeds, and the like), and entomologists.

In this regard, the methods, systems, and computer program products disclosed herein are generally directed toward determining and providing return on investment information for aiding in pest management decisions and assessments. Such determinations may be accomplished by, for example, a computer device executing an appropriate computer program product. For purposes of this discussion, it is recognized and understood that the term ‘computer device’ includes, but is not limited to, desktop and laptop computers, as well as cellular phones, personal digital assistants (PDA), and other electronic devices, both portable and non-portable, having processing capabilities.

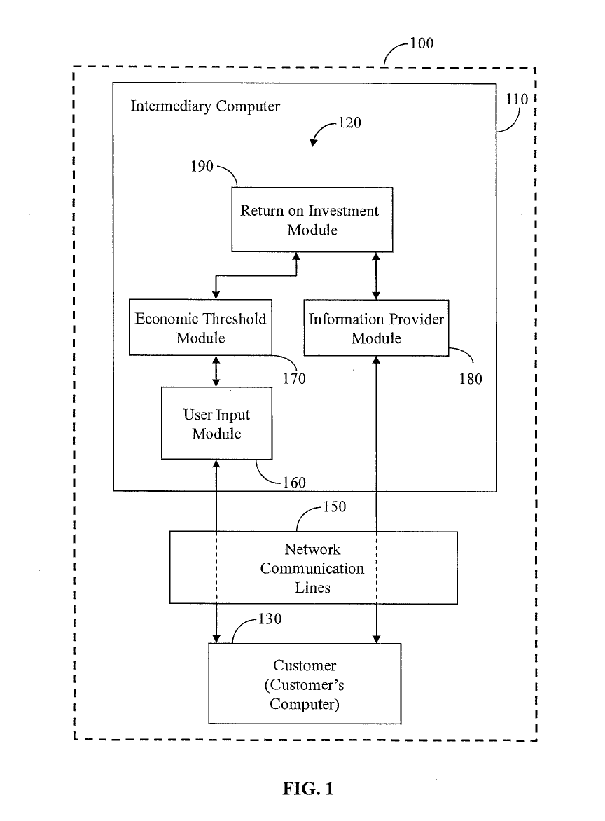

FIG. 1 is a schematic representation of a system, operating over a computer network, for receiving pest sampling data from a user, and for providing pest management information to the user for use in pest management decisions, according to one aspect of the present disclosure, and is representative of a system capable of implementing a method for providing pest management information used in pest management decision-making for a site-specific crop of interest in accordance with further aspects of the present disclosure. The system 120 may be initiated, developed, and administered on an intermediary computer or other computer device 110, wherein the intermediary computer or other computer device 110 is part of a larger computer network 100 such as, for example, the Internet. Such an intermediary computer or computer device 110, referred to herein as “intermediary computer 110” for convenience and brevity, may comprise, for example, a desktop personal computer, a laptop personal computer, a server, a router, a mainframe computer or like devices or combinations thereof capable of implementing the functions and methods described herein as will be appreciated by one skilled in the art.

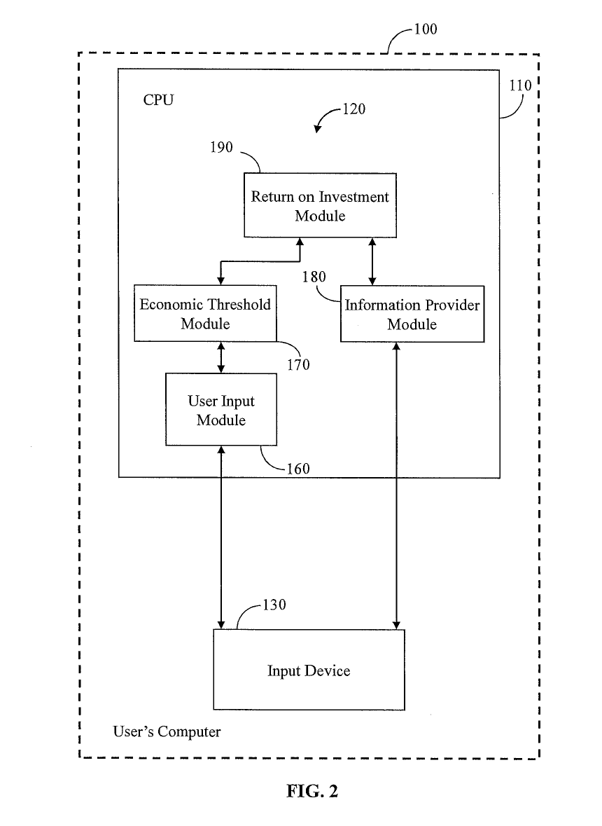

Once established on the intermediary computer 110, the system 120 is accessible to a user through a user's computer 130, referred to herein as “user 130” for convenience and brevity, capable of communicating with the computer network 100 and communicable with the intermediary computer 110 through, for example, network communication lines 150. Note that, while a simple schematic of a single computer device in communication with a computer network is presented herein, it is understood that this concept is representative of communication through an Internet site on, for example, the World Wide Web, and may involve many different computers and associated equipment, wherein the concept of communication via the Internet is known to one skilled in the art. Note that the intermediary computer 110 is typically remote from, discrete, and independent of the user 130. However, in some instances, aspects of the system and corresponding method described herein as being performed by the intermediary computer 110 may be hosted by a user's computer 130 (as shown in FIG. 2), in which case the user's computer 130 may also serve as the intermediary computer 110 consistent with the spirit and scope of the present disclosure.

In order to explore the resources offered by the system 120 such as, for example, to determine a return on investment value for employing a particular pest management strategy, the user 130 accesses the intermediary computer 110 over the network communication lines 150. Generally associated with the system 120 on the intermediary computer 110 are a user input module 160, an economic threshold module 170, an information provider module 180, and a return on investment module 190. The pest management system 120 is generally implemented in computer software, though the system 120 may also, in some instances, be implemented in a combination of software and hardware. The information gathered through the user input module 160, the economic threshold module 170, and/or the return on investment module 190 is generally stored in, for example, one or more databases in a memory device (not shown) incorporated within or otherwise associated with the intermediary computer 110. Accordingly, the system 120 may provide data mining opportunities as will be realized by one skilled in the art. Further, the user input module 160, the economic threshold module 170, the information provider module 180, and the return on investment module 190 are typically implemented in computer software, though these components may be implemented by a combination of software and hardware, in some instances. For example, the economic threshold module 170 and/or the return on investment module 190 may include or be disposed in communication with a router, server, switch, or the like, for appropriately allowing access thereto for retrieving, for example, market prices for a crop of interest and costs associated with one or more pest treatment strategies. In addition, the information provider module 180 may comprise, for instance, a display, a driver, or other mechanism for presenting text, graphics, audio, or the like to display pest-related information, such as, for example, return on investment information, and/or other information associated therewith through the system 120.

Generally, these elements or modules cooperate to form the system 120, implemented in computer software or a combination of software and hardware, including one or more processing portions capable of executing aspects of a method for providing pest management information used in pest management decision-making for a site-specific crop of interest according to the present disclosure. Thus, aspects of such methods according to the present disclosure may be implemented by one or more corresponding processing portions of an associated system or computer device, wherein each processing portion may comprise a software component, or both a software and hardware component, capable of implementing one or more of the specified functions. An associated computer software program product may also be provided, wherein such a computer software program product may include one or more executable portions capable of being executed by an appropriate computer device to perform any or all of the methods described herein. Accordingly, the operation of the pest management system 120 and its associated elements may be more particularly illustrated from the description of an associated method corresponding to one aspect of the present disclosure.

In addition to providing methods, systems, and devices, the present disclosure also provides computer program products for performing the operations described above. The computer program products have a computer readable storage medium having computer readable program code means embodied in the medium. The computer readable storage medium may be part of a storage device and may implement the computer readable program code means to perform the above discussed operations.

In this regard, FIGS. 1 and 2 are block diagram illustrations of methods, systems, and devices according to the disclosure. It will be understood that each block or step of the block diagram and combinations of blocks in the block diagram can be implemented by computer program instructions. These computer program instructions may be loaded onto a computer device or other programmable apparatus to produce a machine, such that the instructions which execute on the computer or other programmable apparatus create means for implementing the functions specified in the block diagram, flowchart or control flow block(s) or step(s). These computer program instructions may also be stored in a computer-readable memory that can direct a computer device or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer device or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

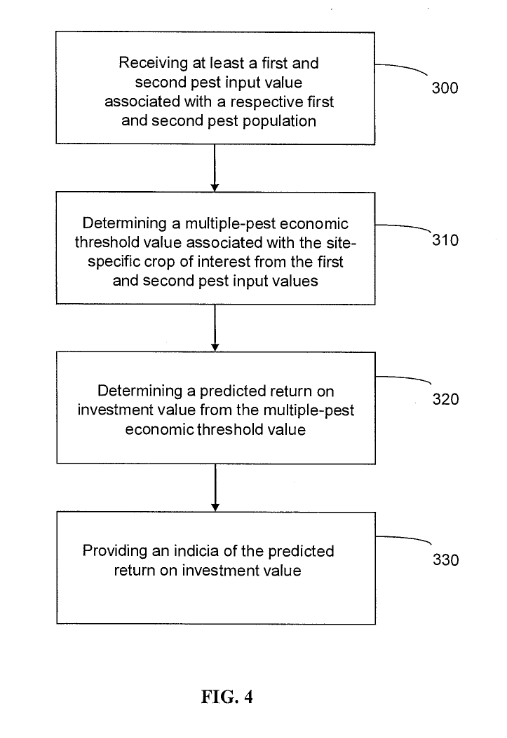

FIG. 4 illustrates a flow chart depicting a method according to one aspect of the present disclosure for providing pest management information used in pest management decision-making for a site-specific crop of interest. The method may comprise, for example, step 300 for receiving at least a first and second pest input value associated with a respective first and second pest population; step 310 for determining a multiple-pest economic threshold value associated with the site-specific crop of interest from the first and second pest input values; step 320 for determining a predicted return on investment value from the multiple-pest economic threshold value; and step 330 for providing an indicia of the predicted return on investment value. Thus, the method aspects of the present disclosure may further display pest management information to a user for aiding in pest management decisions.

The receiving step 300 may comprise in one aspect, for example, monitoring or detecting input from a user regarding information related to a plurality of pest populations, such as, for example, a first and second pest population. That is, the input values associated with the plurality of pest populations is used to determine the return on investment information provided by the various aspects of the present disclosure. Because aspects of the present disclosure are directed toward aiding in pest management decision for multiple pest populations on a site-specific crop, the user may provide pest-related information for at least two species of pests, and, in other instances, more than two species of pests. In this regard, there is no limit on the number of pest input values (i.e., no limit on the number of pest populations that may be considered) that may be received for determining and providing the return on investment information regarding a particular pest control strategy. By way of example, the methods, systems, and computer program products disclosed herein may be used to determine information based on various pest populations such as, for example, black cutworm, corn earworm, western bean cutworm, common stalk borer, fall armyworm, sugarcane borer, European corn borer, southwestern corn borer, western bean cutworm, southern cornstalk borer, beet armyworm, western corn rootworm, northern corn rootworm, Mexican corn rootworm and any other pest population of interest to the user or known by those of skill in the art, including both direct and indirect pests. In this regard, one particular pest population that may be considered an indirect pest population of interest to the user is mycotoxins, which are toxic chemical products produced by fungi that readily colonize crops and are particularly associated with feeding activity of specific insect pests, some of which are common to insect populations of one aspect of the present disclosure.

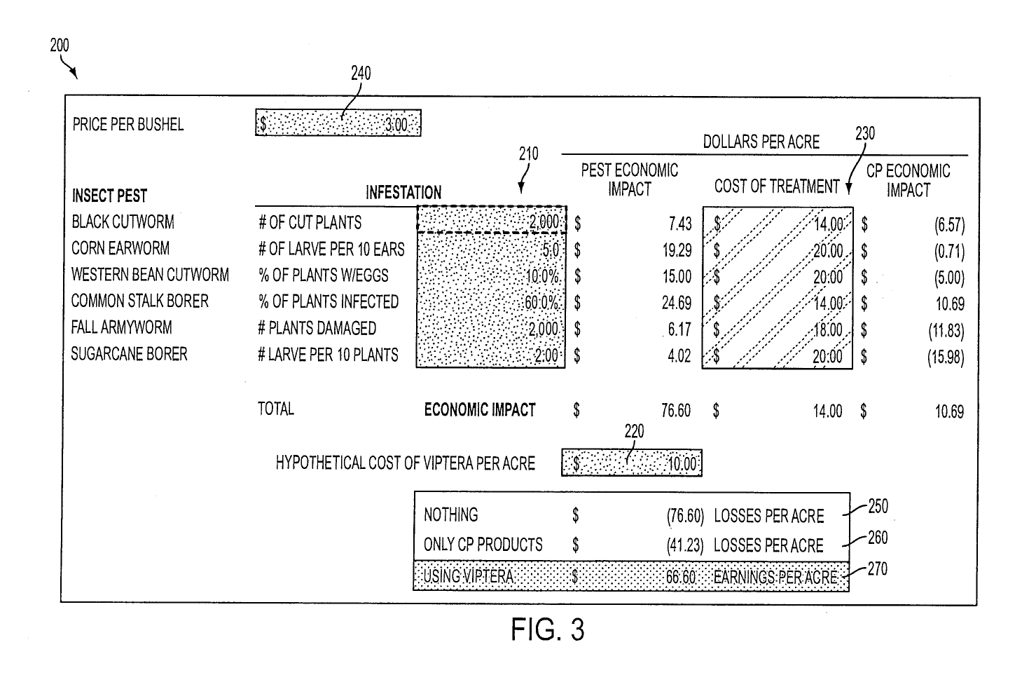

According to some aspects, the receiving step 300 may be performed by a computer device in communication via wired and/or wireless networks (such as the Internet) with a computer device operated by the user. In other instances, the user may access an internet website hosted by a computer device operated by a third-party, wherein the user may “click-through” therethrough to access the internet website. In this manner, the pest input values associated with the pest populations may be received by the third party via the internet website and the return on investment information provided via the internet website operated by the third-party. For example, FIG. 3 illustrates an internet website displayed on a display device such that the user is capable of inputting the pest input values for each of the pest populations affecting a particular crop as determined by the user. Thus, according to some aspects of the present disclosure, the user may access the pest management decision tool via an Internet website configured to present a display 200 shown generally in FIG. 3 such that the user may input pest related information into any one of a plurality of pest input entry fields, as generally and collectively designated 210, shown in the display 200. According to some method, system, and device aspects of the present disclosure, the display 200 shown generally in FIG. 3 may display the pest input entry fields 210 as interactive graphics that may be selected (i.e., by the click of a mouse), causing the display 200 to permit entry of numerical values into the pest input entry fields 210 with, for example, a keyboard device, as understood by those of skill in the art.

In accordance with aspects of the present disclosure, the pest input values associated with each of the particular pest populations present on the site-specific crop of interest may be determined from pest sampling data provided by the user. In this regard, the pest input values may be determined by the user according to various manners. For example, the user may be a grower that has previously recorded information (herein referred to as “historical information”) related to the pest populations infesting the commodities farmed thereby over past growing seasons. In this regard, the data may be obtained by taking manual measurements of the crop of interest with respect to pest infestation thereof. That is, the user may take manual measurements of pest infestation as it relates to each of the pest populations by visually noting characteristics of the field/crop. In other instances, the user may be an entomologist studying the cumulative effects of various pest populations for a specific crop of interest and the associated costs of providing various pest control strategies to manage the pest populations. The sampling data for determining the pest input values may include any information used to develop/determine a single-pest threshold for the respective pest population. For example, the pest sampling data may include the number of cut plants, the number of larvae, the percentage of plants with eggs, the percentage of plants infected, the number of plants damaged, etc. Of course, the term pest sampling data as used herein may include purely hypothetical sampling data provided by a user. That is, the return on investment information provided by aspects of the present disclosure, in some instances, may not be based upon any specific data or otherwise any actual sampling data. Instead, the hypothetical sampling data may used, for example, to imagine various scenarios under which a particular pest control strategy may be more cost effective.

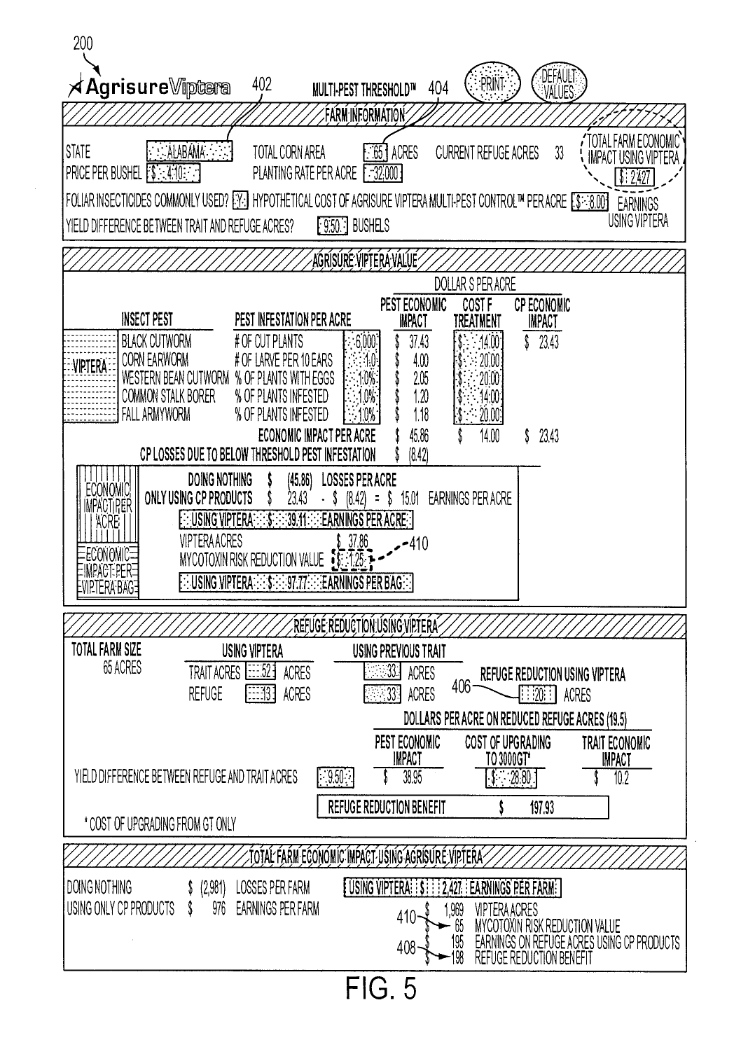

In other instances, the pest input value may include information related to insurance or other risk-reduction programs, wherein the use of a particular pest control strategy may reduce the risk of a particular pest, thereby reducing costs to the grower. For example, the pest input value for mycotoxins may include a risk reduction value, which may be provided the user or otherwise automatically provided such that the return on investment value may be adjusted based on the reduced risk. In one example, lookup tables may be used to access the information associated with the risk reduction value provided for a particular pest population. In addition, return on investment information related to the risk reduction value may be displayed as an indicia 410 (FIG. 5) to assist the user in forming a more-informed decision regarding pest control strategies.

Accordingly, the user's input may be received for ultimately providing return on investment information as it relates to one or more pest control strategies, taking into account the cumulative effects of multiple pest populations infecting a crop at the same or various times during the growing season. According to some aspects, such pest input values may be input in the pest input entry fields 210 associated with the respective pest population, as illustrated in FIG. 3.

Optionally, the user may also be able to input values associated with one or more pest control strategies such that information related thereto may be provided to the user in response to a particular query. For example, the user may input a value associated with the market price of a particular pest control strategy, such as, for example, the market price of a transgenic seed product and/or the market price of a chemical pesticide treatment (either or both of which may also be referred to herein as the “pest treatment price input”). Such information may be used to determine the return on investment values associated with each of the pest control strategies as related to the cumulative damage associated with multiple pest populations. Furthermore, the user may be able to optionally input information related to the crop of interest, such as, for example, the market price of the crop of interest (also referred to herein as the “crop market price input”) such as the price per bushel. In this regard, the display 200 may include a first pest control strategy field 220 for receiving information related to one peSt control strategy (e.g., market price of the transgenic seed), a second pest control strategy field or fields, generally and collectively designated 230, for receiving information related to another pest control strategy (e.g., market price of the chemical pesticides for treating each individual pest population), and a crop of interest field 240 for receiving information related to the crop of interest (e.g., market price of the crop). As mentioned previously, information input by the user may be used in determining the return on investment information provided thereto according to a particular pest control strategy, as further described herein.

However, input of the input values associated with the pest control strategies and/or the crop of interest by the user may be optional. That is, according to some aspects, the input values associated with the pest control strategies and/or the crop of interest may be provided by a third-party or otherwise captured from some other source. For example, the market price of a transgenic seed may be provided by an interne website hosting the pest management tool, such that the user does not have to locate the transgenic seed price or otherwise ensure the accuracy thereof, and is therefore confident that the price accurately reflects the current market price, thereby providing real-time information. In other instances, the market price of a transgenic seed and/or the market price of the crop of interest may be streamed or otherwise provided to the pest management tool/system such that the information may be used in determining the return on investment information provided thereby. In this regard, the input values may be automatically provided to the system such that the user is not required to actively input such information, thereby ensuring to the user that the price information is timely and accurate.

The determining step 310 may comprise in one aspect, for example, determining a multiple-pest economic threshold value associated with the site-specific crop of interest from the pest input values of the various pest populations, as inputted by the user. That is, the pest input values may be used to determine the multiple-pest economic threshold value such that the cumulative effect of multiple pest populations on a single crop can be taken into account in making pest management decisions with respect to various pest control strategies. As mentioned previously, economic threshold is defined as the pest population that produces incremental damage equal to the cost of controlling or preventing that damage. It is the level of pest population where the benefit of pest control is equal to its cost. In this regard, economic threshold may be defined as the pest damage level where the value of incremental reduction in crop yield is equal to the cost of preventing its occurrence. In other words, economic threshold attempts to determine the point at which it becomes economically feasible to control a pest population. In determining a multiple-pest economic threshold, aspects of the present disclosure account for cumulative effects of multiple pest populations infecting a site-specific crop during a growing season. Further, aspects of the present disclosure advantageously account for such pest populations attacking the crop of interest at various times during the growing season (i.e., the pest populations may not infest the crop of interest simultaneously, but the independent damage is nonetheless cumulative), unlike previous attempts to provide multiple-pest economic thresholds. Of course, some aspects of the present disclosure may also account for cumulative damage to the crop of interest due to simultaneous infestation of multiple pest populations.

According to some aspects, the pest input values may be used to determine individual economic thresholds for each pest population of interest for determining the multiple-pest economic threshold. Further, the input values associated with the pest control strategies (e.g., market price of the transgenic seed) and/or the crop of interest (e.g., market price of the crop) may also be used to determine the multiple-pest economic threshold. In some instances, the economic thresholds for the individual pest populations may be calculated or otherwise determined through, for example, ANOVA (analysis of variance) analysis and/or statistical regression analysis/techniques (e.g., regression modeling), as known by those of skill in the art, and for example, as disclosed in Palis et al., A Multiple-Pest Economic Threshold for Rice (A Case Study in the Philippines), in Crop Loss Assessment in Rice, p. 229-242, (International Rice Research Institute 1990), which is incorporated herein by reference in its entirety. Once the individual economic thresholds have been determined, the multiple-pest threshold may be determined by aggregating the particular independent economic thresholds associated with the pest populations indentified by the user as infesting the crop of interest. That is, the multiple-pest economic threshold may be determined as an additive calculation of the individual economic thresholds for each selected pest population as based on the pest sampling data collected and/or provided by the user.

The determining step 320 may comprise in one aspect, for example, determining a predicted return on investment value from the multiple-pest economic threshold value. The term “return on investment” as used throughout the application may not refer to its use in a financial context, but instead may generally refer to the net economic performance (e.g., dollars spent (investment) compared to yield saved (return)) to describe the benefit of various pest management actions. That is, in some instances, the term “return on investment” may generally be used within the meaning of benefits or economic impact, rather than in the traditional financial sense of the term. According to some aspects, the predicted return on investment value may be indicative of the return on investment associated with use of a particular pest control strategy employed by the user for the site-specific crop of interest. For example, the return on investment value may be indicative of a savings attained through implementation of a particular pest control strategy. Such pest control strategies may include, for example, use of an agricultural product (e.g., transgenic seed) as a preventative strategy, use of a chemical pesticide product as a reactive strategy, or no control treatment at all (i.e., using neither a transgenic seed nor a chemical pesticide). That is, a crop grower may determine that it would be beneficial to prevent or substantially reduce pest infestation by using a transgenic seed product, rather than treat the infestation during the growing period thereof through use of the chemical pesticide. In this regard, aspects of the present disclosure are directed toward providing such pest control strategy information to the user such that the user may be capable of making a more-informed decision regarding employment of a particular pest control strategy (i.e., which pest control strategy would provide the most return on investment). Accordingly, using the multiple-pest economic threshold, the return on investment information may be determined for one or multiple pest control strategies such that the user can better determine whether a particular course of action is profitable or otherwise beneficial. Further, in instances where the return on investment information is provided for multiple pest control strategies, the user may easily compare the various pest control strategies from a cost-benefit standpoint.

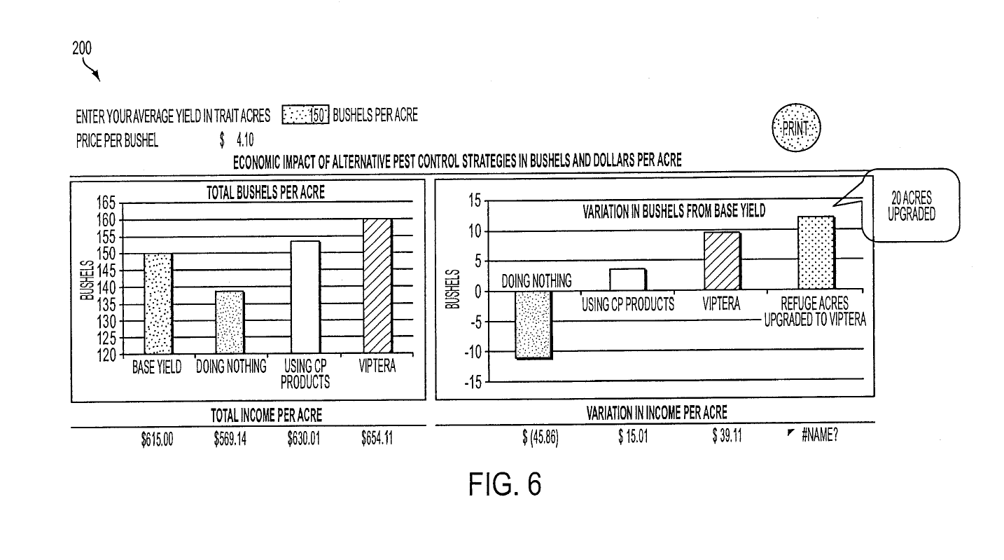

The providing step 330 may comprise in one aspect, for example, providing, notifying, or otherwise displaying an indicia of the return on investment information associated with one or multiple pest control strategies to the user. The indicia of the return on investment information may be displayed on a display screen associated with the computer device of the user. In other instances, the indicia of the return on investment information may be printed on a paper-type medium for the user's viewing. In other aspects, the return on investment information may be communicated or otherwise provided to the user in any suitable manner. As such, the user may be provided with an indicia of the return on investment for a particular pest control strategy. As previously mentioned, in some instances, the user may be provided with the return on investment information for each of a plurality of pest control strategies (e.g., transgenic seed, chemical pesticides, or no pest control treatment) so as to facilitate a comparison therebetween with respect to, for example, a cost-benefit analysis. As shown in FIG. 3, the return on investment information may be provided to the user via the display 200 (see FIG. 3, for example, depicting an Internet webpage that may be accessed by a user according to one aspect of the present disclosure, for viewing return on investment information related to various pest control strategies). For example, the user may be provided with the return on investment information as earnings/losses per acre of the crop of interest for each of the pest control strategies. More specifically, the user may be provided with the indicia of return on investment information for applying no pest control methods 250, for treating the crop of interest with chemical pesticides 260, or for using a modified agricultural product (e.g., transgenic seed) 270 so as to inform the user of the return on investment expected for each of the various pest control strategies. Thus, the user may be provided with real-time information that permits a more-informed decision making process with respect to pest management decisions. In another aspect, as shown in FIG. 6, the user may be provided with a graphical representation of the return on investment information via the display 200 in response to the user inputted pest input values. For example, the user may be provided with information related to various options for managing the various pest populations for a given site in a bar graph display, so as to provide a readily apparent and easily viewable comparison therebetween.

In another aspect of the present disclosure, the user may be provided with information related to refuge reduction as it relates to state-specific guidelines for maintaining appropriate quantities of refuge acreage. Crop growers, such as corn growers, are required to provide refuge areas to help control pest resistance. That is, crop growers must cultivate a certain percentage of acreage without the assistance of certain pest control measures, which is typically determined by an agency such as, for example, the U.S. Environmental Protection Agency (EPA). For example, in some instances, a crop grower may only be permitted to use a transgenic seed product with up to 80% of the crop acreage to control insect pests, wherein at least 20% must be grown without the aid of such transgenic seed product. This determination as to the percentage of acreage may vary from state to state. However, the crop grower may be able to increase the percentage of crop acreage that is grown with the transgenic seed product if specific qualified transgenic seed products are planted, and thereby allowing the crop grower to increase his crop yield by increasing the amount of acreage that can be planted with the pest controlling transgenic seed product. As such, aspects of the present disclosure may provide information related to a decrease in refuge acreage due to use of a particular transgenic seed product, such as, for example, VIPTERAT™. As shown in FIG. 5, the user may input refuge data, such as, for example, the crop grower's state and the total acreage for a particular crop of interest, at appropriate input fields (state field 402 and total acreage field 404). Based upon this information, the user may be provided with additional return on investment information that reflects the expected decrease in refuge acreage, which would expectedly result in increased crop yield and improved return on investment due to an increase in acreage available to implement optimum return on investment decisions regarding pest control strategies. Such return on investment information may be provided, for example, as a total expected refuge reduction value 406 and/or a refuge reduction benefit value 408. In this manner, the user may be provided with further information that affects the decision-making process with respect to pest control strategies.

Accordingly, the method, system, and device in accordance with aspects of the present disclosure may be used to provide pest management information, and, more specifically, to provide return on investment information for one or more pest control strategies or measures such that a more-informed decision can be made by the user with respect to controlling multiple pest populations present on a site-specific crop of interest. In this regard, a business entity selling a particular pest control product for implementing one of the pest control strategies may be able to persuade a crop grower to consider the product by providing such information thereto by comparing various other pest control measures with the return on investment information associated with the particular pest control product offered by the business entity.

Having now described the pest management system for providing pest management information used in pest management decision-making related to implementation of pest control strategies for a crop of interest, an exemplary pest management method, system, and device in accordance with aspects of the present disclosure will now be provided. In one example, the user, such as a grower of the crop of interest (e.g., corn), may collect pest sampling data specific to the crop and site with respect to infestation of at least two pest populations, which cause cumulative crop damage. Upon collecting such pest sampling data, the user may then input such pest sampling data into the pest input entry fields 210 via a keyboard device. For example, as shown in FIG. 3, the user may input pest sampling data in the appropriate form as pest input values recognized by the system 120 for each of black cutworm, corn earworm, western bean cutworm, common stalk borer, fall armyworm, and sugarcane borer. This inputted information may vary for each pest population, as illustrated in FIG. 3 (e.g., number of cut plants for black cutworm (in some instances, the percent of cut plants may be used for black cutworm and/or fall armyworm), number of larvae per 10 ears of corn for corn earworm, etc.). In addition, the user may, in some instances, also enter the market price of the crop of interest into the crop of interest field 240 in the appropriate form as the crop market price input. Further, the user may, in some instances, also enter the market price of products associated with one or more pest control strategies. For example, the user may provide the market price of a transgenic seed product in the first pest control strategy field 220 in the appropriate form as the pest treatment price input. Further, in some instances, the user may also provide the market price of a chemical pesticide product for treating each individual pest population in the second pest control strategy fields 230 in the appropriate form as the pest treatment price input.

Using these various input values, some of which may be automatically provided (as described previously), the multiple-pest economic threshold may be determined so as to account for the predicted cumulative damage of the multiple pest populations on the site-specific crop of interest, which also accounts for infestation of the pest populations at various times during the growing season (i.e., the pest populations infest the crop of interest at various growth stages thereof). That is, aspects of the present disclosure do not take the approach of only examining pest populations that are simultaneously active on the crop of interest (i.e., more than one pest population present at the same time). Instead, aspects of the present disclosure consider pest populations that are active at different times, while also considering pest populations that may be active at the same time. In this regard, using a biotech trait (e.g., transgenic seed) to control pest populations permits aspects of the present disclosure to take this approach because the biotech trait of transgenic seed is active all season long and therefore controls pest populations over a much wider time frame compared to a single chemical pesticide (e.g., insecticide) application. Furthermore, the pest populations accounted for in aspects of the present disclosure may not be active at the same time, sometimes due to geographical differences in which they occur (sugar cane borer versus western bean cutworm, for example). In addition, aspects of the present disclosure may address pest populations that are active at a single timing during the growth season (e.g., black cutworm in seedling corn and corn earworm during grainfill).

Using, for example, statistical regression analysis (e.g., regression modeling) or ANOVA relationships based on the inputs provided by the user and/or automatically provided to the system, individual economic thresholds may be determined for each of the pest populations. Aggregating these individual economic thresholds, the multiple-pest economic threshold may be determined. Accordingly, the multiple-pest economic threshold may be used to determine the return on investment information with respect to the one or more pest control strategies, as applied to the site-specific crop of interest. The indicia of the return on investment information may then be displayed on the display 200 to the user. For example, the return on investment for simply employing no type of pest control measure may be provided as the indicia 250 (e.g., showing a predicted loss of $76.60 per acre). Further, the return on investment for implementing a chemical pesticide treatment strategy may be provided as the indicia 260 (e.g., showing a predicted loss of $41.23). Finally, the return on investment for using a modified agricultural product such as a transgenic seed product may be provided as the indicia 270 (e.g., showing a predicted earning of $66.60), wherein the return on investment value may be represented by the indicia 270 in various manners, such as, for example, by illustrating the advantage of a transgenic seed product on a per acre basis, a per unit basis, or both. As such, the user may be provided with information used to aid the user in making pest management decisions with respect to which pest control strategy to employ, or none at all. Of course, one of ordinary skill in the art will recognize that pest populations and other variables associated with this example may be altered to suitable preferences by the user and/or participating business entity/entities, and such an example is not meant to limit the disclosure herein in any manner.

Various method and computer program product aspects of the present disclosure may also provide a “turn-key” pest management program for the user. For example, in some aspects, the providing step 330 may comprise providing the return on investment information to the user via an internet website and/or other visual display 200 that includes a logo, color scheme, background, trademarks, and/or trade dress that represents an entity providing one or more of the pest control strategies being considered by the user.

Many modifications and other aspects of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for purposes of limitation.

That which is claimed:

1. A computer device adapted for interaction with a user and configured to provide pest management information used in pest management decision-making related to implementation of pest control measures for a crop of interest, the computer device comprising:
a processing portion for receiving from a user a first and second pest input value associated with a respective first and second pest population, the first and second pest input values corresponding to pest sampling data associated with the respective first and second pest population for a site-specific crop of interest;
a processing portion for determining a multiple-pest economic threshold value associated with the site-specific crop of interest from the first and second pest input values;
a processing portion for determining a predicted return on investment value from the multiple-pest economic threshold value, the predicted return on investment value being indicative of the return on investment associated with use of a pest control strategy for the site-specific crop of interest; and
a processing portion for providing an indicia of the predicted return on investment value, so as to provide pest management information to the user for aiding in pest management decisions.

2. A computer device according to claim 1 wherein the processing portion for determining a predicted return on investment value is further configured to determine a predicted return on investment value for each of a first and second pest control strategy, and the processing portion for providing an indicia of the predicted return on investment value is further configured to provide an indicia of the predicted return on investment value for each of the first and second pest control strategies, so as to provide a comparison between the predicted return on investment values of the first and second pest control strategies.

3. A computer device according to claim 2 wherein the first pest control strategy comprises a transgenic seed measure and the second pest control strategy comprises a chemical pesticide treatment plan.

4. A computer device according to claim 1 wherein the processing portion for receiving a first and second pest input value is further configured to receive the first and second pest input values corresponding to pest sampling data comprising pest infestation data.

5. A computer device according to claim 1 further comprising a processing portion for receiving from the user a crop market price input associated with a market price of the site-specific crop of interest, and a transgenic seed price input associated with a market price of a transgenic seed used to control the first and second pest populations with respect to the site-specific crop of interest, the crop market price input and the transgenic seed price input being used to determine the predicted return on investment value.

6. A computer device according to claim 1 wherein the processing portion for providing an indicia of the predicted return on investment value is further configured to provide the indicia to a display unit for displaying the indicia to the user.

7. A computer device according to claim 1 wherein the processing portion for determining a multiple-pest economic threshold value is further configured to determine a multiple-pest economic threshold from a plurality of single-pest economic thresholds, each of the first and second pest populations having a single-pest economic threshold associated therewith as determined by the respective first and second pest input values.

8. A computer device according to claim 1 further comprising a processing portion for providing an indicia of a risk reduction value associated with insurance parameters established for implementing the pest control strategy for the site-specific crop of interest for at least one of the first and second pest populations.

9. A computer device according to claim 1 wherein the processing portion for providing an indicia of the predicted return on investment value is further configured to provide an indicia of the predicted return on investment value associated with refuge reduction as determined from refuge reduction data associated with implementation of the pest control strategy for effectively reducing refuge acreage.

10. An intermediary computer device configured to implement a system for providing pest management information used in pest management decision-making for a site-specific crop of interest, the intermediary computer device being configured to be in communication with a computer network so as to be capable of communicating with a discrete computer device adapted to be used by the user, said intermediary computer device comprising:
a processing portion for receiving from a user a first and second pest input value associated with a respective first and second pest population, the first and second pest input values corresponding to pest sampling data associated with the respective first and second pest population for a site-specific crop of interest;
a processing portion for determining a multiple-pest economic threshold value associated with the site-specific crop of interest from the first and second pest input values;
a processing portion for determining a predicted return on investment value from the multiple-pest economic threshold value, the predicted return on investment value being indicative of the return on investment associated with use of a pest control strategy for the site-specific crop of interest; and
a processing portion for providing an indicia of the predicted return on investment value, so as to provide pest management information to the user for aiding in pest management decisions.

11. An intermediary computer device according to claim 10 wherein the processing portion for determining a predicted return on investment value is further configured to determine a predicted return on investment value for each of a first and second pest control strategy, and the processing portion for providing an indicia of the predicted return on investment value is further configured to provide an indicia of the predicted return on investment value for each of the first and second pest control strategies, so as to provide a comparison between the predicted return on investment values of the first and second pest control strategies.

12. An intermediary computer device according to claim 11 wherein the first pest control strategy comprises a transgenic seed measure and the second pest control strategy comprises a chemical pesticide treatment plan.

13. An intermediary computer device according to claim 10 wherein the processing portion for receiving at least a first and second pest input value is further configured to receive the first and second pest input values corresponding to pest sampling data comprising pest infestation data.

14. An intermediary computer device according to claim 10 further comprising a processing portion for receiving a crop market price input associated with a market price of the site-specific crop of interest, and a transgenic seed price input associated with a market price of a transgenic seed used to control the first and second pest populations with respect to the site-specific crop of interest, the crop market price input and the transgenic seed price input being used to determine the predicted return on investment value.

15. An intermediary computer device according to claim 10 wherein the processing portion for providing an indicia of the predicted return on investment value is further configured to provide the indicia to a display unit for displaying the indicia to the user.

16. An intermediary computer device according to claim 10 wherein the processing portion for determining a multiple-pest economic threshold value is further configured to determine a multiple-pest economic threshold from a plurality of single-pest economic thresholds, each of the first and second pest populations having a single-pest economic threshold associated therewith as determined by the respective first and second pest input values.

17. An intermediary computer device according to claim 10 further comprising a processing portion for providing an indicia of a risk reduction value associated with insurance parameters established for implementing the pest control strategy for the site-specific crop of interest for at least one of the first and second pest populations.

18. An intermediary computer device according to claim 10 wherein the processing portion for providing an indicia of the predicted return on investment value is further configured to provide an indicia of the predicted return on investment value associated with refuge reduction as determined from refuge reduction data associated with implementation of the pest control strategy for effectively reducing refuge acreage.

19. A system for providing pest management information used in pest management decision-making for a site-specific crop of interest, said system comprising:
a first computer device configured to be in communication with a computer network, the first computer device comprising:
a processing portion for receiving from a user a first and second pest input value associated with a respective first and second pest population, the first and second pest input values corresponding to pest sampling data associated with the respective first and second pest population for a site-specific crop of interest;
a processing portion for determining a multiple-pest economic threshold value associated with the site-specific crop of interest from the first and second pest input values;
a processing portion for determining a predicted return on investment value from the multiple-pest economic threshold value, the predicted return on investment value being indicative of the return on investment associated with use of a pest control strategy for the site-specific crop of interest; and
a processing portion for providing an indicia of the predicted return on investment value, so as to provide pest management information to the user for aiding in pest management decisions.

20. A system according to claim 19 further comprising a processing portion for receiving a crop market price input associated with a market price of the site-specific crop of interest, and a transgenic seed price input associated with a market price of a transgenic seed used to control the first and second pest populations with respect to the site-specific crop of interest, the crop market price input and the transgenic seed price input being used to determine the predicted return on investment value.

21. A method for providing pest management information used in pest management decision-making for a site-specific crop of interest, the method comprising:
receiving from a user a first and second pest input value associated with a respective first and second pest population, the first and second pest input values corresponding to pest sampling data associated with the respective first and second pest population for a site-specific crop of interest;
determining with a processor portion a multiple-pest economic threshold value associated with the site-specific crop of interest from the first and second pest input values;
determining with a processor portion a predicted return on investment value from the multiple-pest economic threshold value, the predicted return on investment value being indicative of the return on investment associated with use of a pest control strategy for the site-specific crop of interest; and
providing an indicia of the predicted return on investment value, so as to provide pest management information to the user for aiding in pest management decisions.

22. A method according to claim 21 wherein determining a predicted return on investment value further comprises determining a predicted return on investment value associated with each of a first and second pest control strategy, and providing an indicia of the predicted return on investment value further comprises providing an indicia of the predicted return on investment value for each of the first and second pest control strategies, so as to provide a comparison between the predicted return on investment values of the first and second pest control strategies.

23. A method according to claim 22 wherein the first pest control strategy comprises a transgenic seed measure and the second pest control strategy comprises a chemical pesticide treatment plan.

24. A method according to claim 21 wherein receiving at least a first and second pest input value further comprises receiving first and second pest input values corresponding to pest sampling data comprising pest infestation data.

25. A method according to claim 21 further comprising receiving a crop market price input associated with a market price of the site-specific crop of interest, and a transgenic seed price input associated with a market price of a transgenic seed used to control the first and second pest populations with respect to the site-specific crop of interest, the crop market price input and the transgenic seed price input being used to determine the predicted return on investment value.

26. A method according to claim 21 wherein providing an indicia of the predicted return on investment value further comprises displaying the indicia to the user by a display unit.

27. A method according to claim 21 wherein determining a multiple-pest economic threshold value further comprises determining a multiple-pest economic threshold from a plurality of single-pest economic thresholds, each of the first and second pest populations having a single-pest economic threshold associated therewith as determined by the respective first and second pest input values.
